(19) United States
(12) Patent Application Publication
(10) Pub. No.: US 2017/0113916 A1
(43) Pub. Date: Apr. 27, 2017

(54) MECHANICALLY CRIMPED FIBER TOW HAVING INCREASED BULK AND CRIMP TAKE-UP

(71) Applicant: INVISTA NORTH AMERICA S.AR.L., WILMINGTON, DE (US)

(72) Inventor: Don M SALISBURY, Cartersville, GA (US)

(73) Assignee: INVISTA NORTH AMERICA S.AR.L., WILMINGTON, DE (US)

(21) Appl. No.: 15/318,098

(22) PCT Filed: Jun. 12, 2015
(86) PCT No.: PCT/US2015/035569

§ 371 Date: Dec. 12, 2016

Related U.S. Application Data
(60) Provisional application No. 62/011,863, filed on Jun. 13, 2014.

(51) Int. Cl. B68G 3/06

(52) U.S. Cl. CPC B68G 3/06

(57) ABSTRACT

An improved fiber tow and process for forming the same is disclosed. The fiber tow may include a plurality of mechanically crimped fibers with a primary crimp having a saw tooth crimp shape. For fiber tows comprising fibers with denier per filament of greater than about 5, the plurality of mechanically crimped fibers have an average crimp take-up of greater than about 40%. For fiber tows comprising fibers with denier per filament of less than about 5, the plurality of mechanically crimped fibers have an average crimp take-up of greater than about 30%.

### FIELD OF THE INVENTION

The present disclosure is directed to a mechanically crimped fiber tow, and more particularly, to a mechanically crimped fiber tow having increased bulk and crimp take-up (CTU).

### BACKGROUND OF THE INVENTION

Fiber tows, which can be cut into staple fibers, are often used to make many non-woven products, such as, for example, the filling of bedding products, furniture, and stuffed toys. Some fiber tows remain uncut and are processed into spreadable tows used to fill articles such as pillows, duvets and sleeping bags. The opening of the fiber tows and staple fiber is often called high loft non-woven or fiberfill when used to fill articles. The fiber tow fill space in interior areas of the products and impart compression support and loft. The fiber tows that have higher compression support and loft are desirable because less material can be used in the products, thereby lowering production costs and environmental footprint. One way to increase compression support and loft is to crimp the fiber tows. It is known in the art that retaining the crimp shape is important to increasing compression support and loft.

There are generally three primary crimp shapes within non-woven products: (1) mechanical crimp (i.e., a saw-tooth crimp), (2) a spiral conjugate, and (3) an omega conjugate (i.e., asymmetric or jet quench). Crimp properties can be measured by primary crimp frequency measurements, crimp index (e.g., crimp take-up (CTU)), and bulk measurements. Higher crimp frequency and CTU values indicate higher compression support and loft. Historically, the conjugate shapes have imparted higher bulk and crimp-take-up (CTU) values than mechanical crimp shapes.

However, one of the problems with manufacturing conjugate shapes is that they are very difficult to manufacture at low denier per filament (dpf) values. Mechanically crimped shapes, on the other hand, experience significantly less processing difficulty with fibers having low dpf values. As fibers having low dpf values are becoming more attractive to customers because of their aesthetic and performance properties, it is desirable to impart higher bulk and CTU values on lower dpf fibers. In addition, it is desirable to use mechanical crimp shapes to impart bulk and CTU values approaching to those of the conjugate shapes, thereby allowing fibers of all dpf values to be used for the fiber tow, which leads to lowering production costs and environmental footprint.

### SUMMARY OF THE INVENTION

The disclosed fiber tow is directed to overcoming one or more of the problems set forth above and/or other problems of the prior art. As used herein, “fiber tow” refers to a continuous bundle of textured fiber.

In a first aspect, the present disclosure is directed to a fiber tow. The fiber tow may include a plurality of mechanically crimped fibers with a primary crimp having a saw tooth crimp shape. Each fiber may have an average denier per filament of greater than about 5. The plurality of mechanically crimped fibers may have an average crimp take-up of greater than about 40%.

In a second aspect, the present disclosure is directed to a fiber tow. The fiber tow may include a plurality of mechanically crimped fibers with a primary crimp having a saw tooth crimp shape. Each fiber may have an average denier per filament of less than about 5. The plurality of mechanically crimped fibers have an average crimp take-up of greater than about 30%.

In a third aspect, the present disclosure is directed to an article of manufacture comprising a plurality of fiber tows. The fiber tows may comprise a plurality of mechanically crimped fibers with a primary crimp having a saw tooth crimp shape. For articles comprising fibers with denier per filament of greater than about 5, the plurality of mechanically crimped fibers have an average crimp take-up of greater than about 40%. For articles comprising fibers with denier per filament of less than about 5, the plurality of mechanically crimped fibers have an average crimp take-up of greater than about 30%.

In a fourth aspect, the present disclosure is directed to a pillow. The pillow may include a plurality of fiber tows. The fiber tows may comprise a plurality of mechanically crimped fibers with a primary crimp having a saw tooth crimp shape. For pillows comprising fibers with denier per filament of greater than about 5, the plurality of mechanically crimped fibers have an average crimp take-up of greater than about 40%. For pillows comprising fibers with denier per filament of less than about 5, the plurality of mechanically crimped fibers have an average crimp take-up of greater than about 30%.

In a fifth aspect, the present disclosure is directed to a staple fiber bundle comprising a plurality of mechanically crimped fibers with a primary crimp having a saw tooth crimp shape. For staple fiber bundles comprising fibers with denier per filament of greater than about 5, the plurality of mechanically crimped fibers have an average crimp take up of greater than about 40%. For staple fiber bundles comprising fibers with denier per filament of less than about 5, the plurality of mechanically crimped fibers have an average crimp take-up of greater than about 30%.

In a sixth aspect, the present disclosure is directed to an article of manufacture comprising a plurality of staple fiber bundles. The staple fiber bundles may comprise a plurality of mechanically crimped fibers with a primary crimp having a saw tooth crimp shape. For staple fiber bundles comprising fibers with denier per filament of greater than about 5, the plurality of mechanically crimped fibers have an average crimp take-up of greater than about 40%. For staple fiber bundles comprising fibers with denier per filament of less than about 5, the plurality of mechanically crimped fibers have an average crimp take up of greater than about 30%.

In a seventh aspect, the present disclosure is directed to a pillow. The pillow may include a plurality of staple fiber bundles. The staple fiber bundles may comprise a plurality of mechanically crimped fibers with a primary crimp having a saw tooth crimp shape. For staple fiber bundles comprising fibers with denier per filament of greater than about 5, the plurality of mechanically crimped fibers have an average crimp take-up of greater than about 40%. For staple fiber bundles comprising fibers with denier per filament of less than about 5, the plurality of mechanically crimped fibers have an average crimp take-up of greater than about 30%.

In an eighth aspect, the present disclosure is directed to a batting comprising a plurality of fiber tows. The fiber tows may comprise a plurality of mechanically crimped fibers with a primary crimp having a saw tooth crimp shape. For battings comprising fibers with denier per filament of greater than about 5, the plurality of mechanically crimped fibers have an average crimp take-up of greater than about 40%. For battings comprising fibers with denier per filament of less than about 5, the plurality of mechanically crimped fibers have an average crimp take-up of greater than about 30%.

In a ninth aspect, the present disclosure is directed to a process for forming a fiber tow including a plurality of mechanically crimped fibers. The process may include conveying a fiber tow including a plurality of substantially uncrimped fibers towards a stuffer box, and imparting a primary mechanical crimp in a saw tooth crimp shape on the fiber tow. The process may also include conveying the fiber tow including a plurality of substantially crimped fibers in a substantially compact form immediately into a relaxing oven. The process may further include heating the fiber tow via the relaxing oven to crystalize and shrink the fiber tow.

### BRIEF DESCRIPTION OF FIGURES

FIG. 1 is a schematic illustration of an exemplary disclosed system for mechanically crimping a fiber tow.

FIG. 2 is a schematic illustration of the disclosed system of FIG. 1, including an additional portion used by a prior art system for handling the fiber tow after crimping.

FIG. 3 is a schematic illustration of the disclosed system of FIG. 1, including an additional portion used by the disclosed system for handling the fiber tow after crimping.

FIGS. 4a-c are pictorial illustrations of the disclosed fiber tow at different stages of processes performed by the systems of FIGS. 2 and 3.

### DETAILED DESCRIPTION OF THE INVENTION

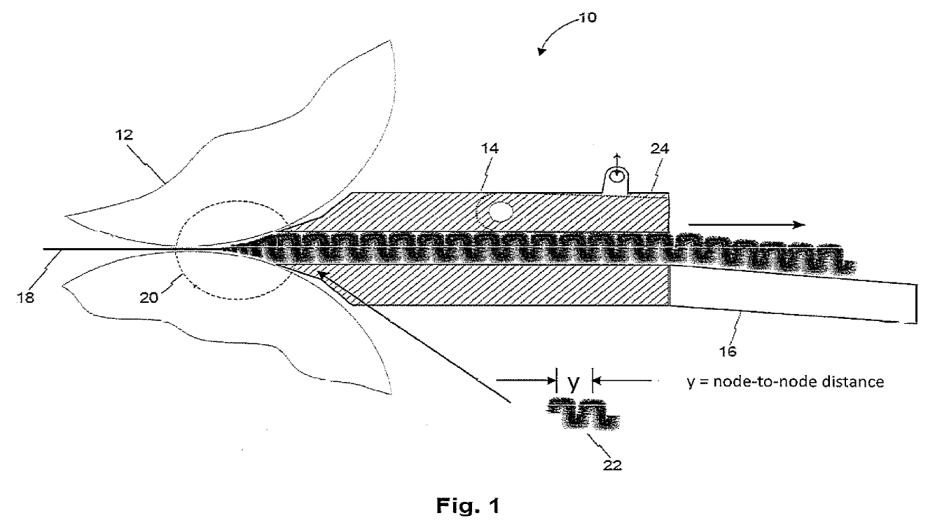

FIG. 1 illustrates system 10 for mechanically crimping a fiber tow. The disclosed fiber tow may have a denier range of about 10,000 denier to about 7 million denier. In certain embodiments, the disclosed fiber tow can have a denier range of from about 50,000 denier to about 7 million denier, about 100,000 denier to about 6 million denier, about 200,000 denier to about 5 million denier, from about 200,000 denier to about 3 million denier, from about 200,000 denier to about 2 million denier, from about 200,000 denier to about 1.5 million denier, and from about 1 million denier to about 3 million denier. The disclosed fiber tow may have a width ranging from about 0.5 inches to about 50 inches. In certain embodiments, the width of the fiber tow ranges from about 1 to about 34 inches. In certain embodiments, the width of the fiber tow ranges from about 0.5 inch to about 24 inches, about 0.5 inch to about 18 inches, about 0.5 inch to about 12 inches, about 1 inch to about 6 inches, about 2 inches to about 24 inches, about 2 inches to about 18 inches, about 2 inches to about 12 inches, about 2 inches to about 6 inches, about 3 inches to about 24 inches, about 3 inches to about 18 inches, about 3 inches to about 12 inches, and about 3 inches to about 8 inches. In articles of manufacture, the fiber tow may be utilized in uncut or cut form.

System 10 may include a crimping wheel 12, stuffer box 14, and conveyor belt 16. Crimping wheel 12 may be located upstream of stuffer box 14, and conveyor belt 16 may be configured to convey a fiber tow 18 between crimping wheel 12 and stuffer box 14 along a substantially longitudinal axis. System 10 may be used with fiber tows 18 having a plurality of fibers with a wide range of denier per filament (dpf) values. In one embodiment, system 10 may be used with fibers having dpf values of about 0.5 to 40 dpf.

Crimping wheel 12 may be configured to impart one or more mechanical crimp shapes on a substantially uncrimped fiber tow 18, such as a freshly drawn fiber tow. For example, crimping wheel 12 may impart a primary crimp 20 having a saw tooth crimp shape. In nonlimiting embodiments, the shape of the saw tooth crimp may be sharp or they may be more rounded. In some embodiments, primary crimp 20 may have a crimp frequency ranging from about 1 crimp per inch to about 20 crimps per inch. It is contemplated that fiber tow 18 may have a substantially rectangular body, as shown in FIG. 1, however, any other shapes may be used, as desired. In certain embodiments, the plurality of fibers may have a dpf value ranging from about 6 to about 20 dpf and may have a crimp per inch value ranging from 4 to 9. In other embodiments, the plurality of fibers may have a dpf value ranging from about 0.8 to about 2 dpf may have a crimp per inch value ranging from 6 to 14.

Stuffer box 14 may be configured to receive fiber tow 18 after exiting crimping wheel 12, and impart one or more additional crimp shapes on fiber tow 18. For example, because of the physical boundaries of stuffer box 14 and pressure applied at a stuffer box flap 24, stuffer box 14 may impart secondary crimp 22 on fiber tow 18 also having a saw tooth shape. In some embodiments, secondary crimp 22 may have a crimp frequency ranging from about 2 crimps per inch to about 20 crimps per inch, such as from about 2 crimps per inch to about 10 crimps per inch, and from about 4 crimps per inch to about 8 crimps per inch. In one embodiment, a ratio between primary crimp 20 to secondary crimp 22 may range from about 20:1 to 2:7, such as from 5:1 to 5:7, and 1:1.

The crimp frequency of primary and secondary crimps 20, 22 may indicate a retention of the respective crimps, and result in higher bulk (i.e., springiness) and/or a crimp index (e.g., crimp-take-up (CTU)) of fiber tow 18. The bulk and CTU of fiber tow 18 may be valuable in non-woven products, especially high-loft, non-woven products. Multiple parameters may contribute to imparting of primary and secondary crimp 20, 22, including, for example, a fiber orientation, a temperature of fiber tow 18 going into crimping wheel 12, an amount of heat while inside stuffer box 14, an amount of pressure imparted on fiber tow 18 from stuffer box flap 24, and how fiber tow 18 is handled after stuffer box 14.

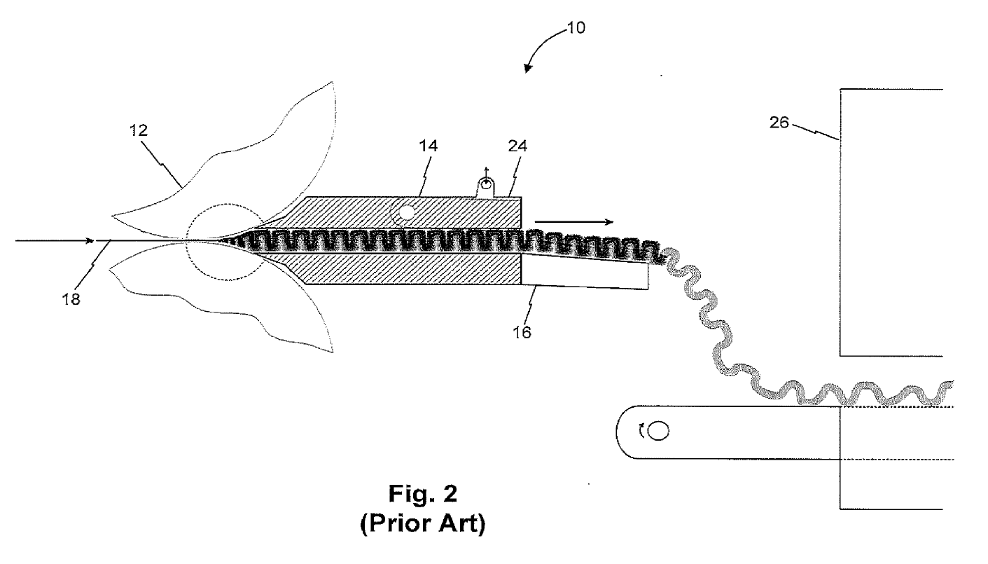

As shown in FIG. 2, typical prior art systems may drop crimped fiber tow 18 down to a second conveyor belt prior to heating fiber tow 18. The drop off in these systems can range from about 1 to about 6 feet. As shown in FIG. 2, fiber tow 18 loses more and more of its crimp shape as it falls farther from conveyor belt 16, due at least to gravitational forces. Only once fiber tow 18 has fallen a drop off distance is fiber tow 18 fed into a relaxing oven for heating. However, at this point, fiber tow 18 has stretched and lost a significant amount of crimp shape, thereby lowering the bulk and CTU values of fiber tow 18. Also, fiber tow 18 begins to cool once it exits stuffer box 14, and in some applications, higher drop down distances can cause fiber tow 18 to lose significant crimp shape and CTU. Without being bound to any particular theory, it is believed that the loss of crimp shape and CTU is increased if the fiber is above the glass transition temperature of the polymer.

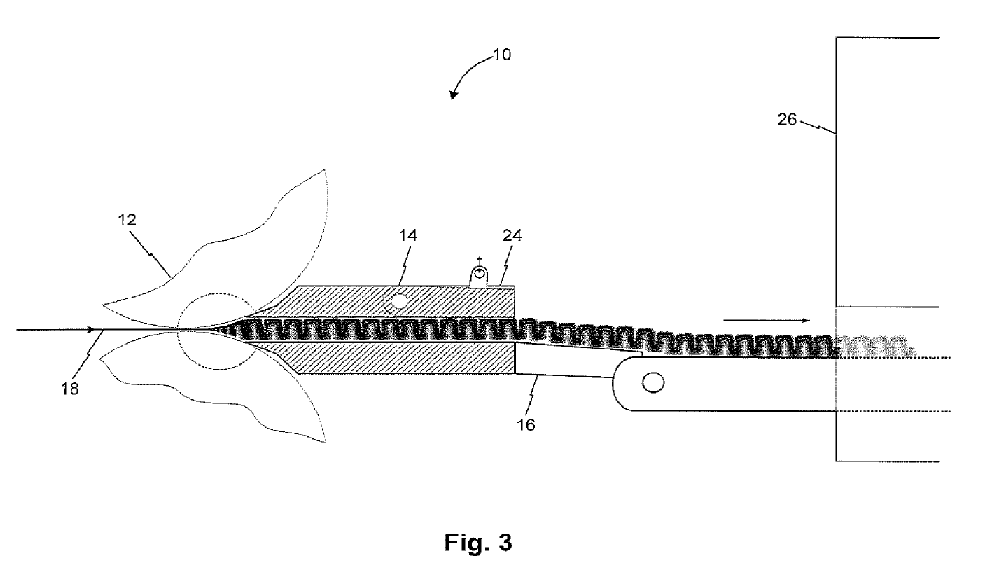

In certain embodiments of the present disclosure, as shown in FIG. 3, system 10 can convey fiber tow 18 in a substantially compact form after exiting stuffer box 14, and subsequently convey fiber tow 18 into a relaxing oven 26. As used herein, the term “substantially compact form” refers to maintaining the node to node distance of the secondary crimp 22 within 25% from the exiting of the stuffer box 14 to the laydown of the fiber tow on the relaxer oven belt. As is well known in the art, the node to node (or peak to peak) distance can be measured to determine the separation of crimp in a fiber tow. As can be seen in FIG.1, the node to node distance for the secondary crimp 22 is represented by the value Y. Eq. 1 shows how the change in node to node distance was calculated. Y_{After} represents the node to node distance when the fiber tow reaches the relaxer oven belt. Y_{Begin} represents the node to node distance when the fiber tow exits the stuffer box 14. The percent change of the node to node distance of the inventive samples shown in Table 2 was found to be less than 1%. Without being bound any particular theory, it is believed that values greater than 25% reduce the CTU and bulk of the fiber tow 18 while values greater than 50% significantly reduce CTU and bulk retention.

$$\% Change in Node to Node Distance = \frac{{Y}_{After} - {Y}_{Begin}}{{Y}_{Begin}} \times 100 \% \qquad Eq . 1$$

The substantially compact form of the fiber tow may prevent primary and secondary crimps 20, 22 from opening up and/or stretching. In one embodiment, system 10 can convey fiber tow 18 along a substantially longitudinal axis after exiting stuffer box 14, and subsequently convey fiber tow 18 immediately into relaxing oven 26. As used herein, the term “substantially longitudinal axis” refers to the longitudinal axis of stuffer box 14 within about ±10%. In another embodiment, system 10 can convey fiber tow 18 to a substantially perpendicular axis to the longitudinal axis of stuffer box 14 after exiting stuffer box 14. In yet another embodiment, system 10 may include a device for supporting fiber tow 18 to protect primary and secondary crimps 20, 22. The support may counteract the effect of gravity on primary and secondary crimps 20, 22.

In some embodiments, before entering the relaxing oven 26, fiber tow 18 may be cooled to below a glass transition temperature of the fibers associated with fiber tow 18. For example, fiber tow 18 may be cooled by ambient air and/or any cooling device known in the art, as desired. In some embodiments, a distance between stuffer box 14 and relaxing oven 26 may contribute to an amount of cooling. Specifically, more distance between stuffer box 14 and relaxing oven 26 may result in more cooling of fiber tow 18 because fiber tow 18 can be exposed to ambient air for a longer duration. In certain embodiments, the glass transition temperature of the fibers may be about 40° C. to about 80° C., and in particular embodiments, the glass transition temperature ranges from about 60° C. to about 70° C., such as about 65° C.

Once inside relaxing oven 26, fiber tow 18 can be heated to a temperature ranging from about 80F° C. to about 190° C. In certain embodiments of the present disclosure, fiber tow 18 can be heated to a temperature of about 170° C. Within relaxing oven 26, fiber tow 18 can crystalize and shrink about 5-30%. In contrast to the prior art system shown in FIG. 2, however, fiber tow 18 of the present disclosure may be kept in a compact form without losing a significant amount of crimp shape. As a result, fiber tow 18 may achieve higher bulk and CTU values, and thereby, result in higher compression support and loft. In certain embodiments, after exiting the relaxing oven 26 but prior to cutting, fiber tow 18 may be cooled to below a glass transition temperature of the fibers associated with fiber tow 18.

In one nonlimiting aspect of the present invention, a process for process for forming a fiber tow including a plurality of mechanically crimped fibers is disclosed. The process comprises (a) conveying a fiber tow including a plurality of substantially uncrimped fibers towards a stuffer box, (b) imparting a primary mechanical crimp in a saw tooth crimp shape on the fiber tow, (c) conveying the fiber tow including a plurality of substantially crimped fibers in a substantially compacted form immediately into a relaxing oven; and (d) heating the fiber tow via the relaxing oven to crystalize and shrink the fiber tow. In one nonlimiting embodiment, the process further includes cooling the fiber tow exiting the relaxing oven to a temperature below a glass transition temperature of the fiber tow. In another nonlimiting embodiment, the average crimp take-up the fiber tow formed is at least 40% greater than the average crimp take-up a fiber tow not subject to step (c).

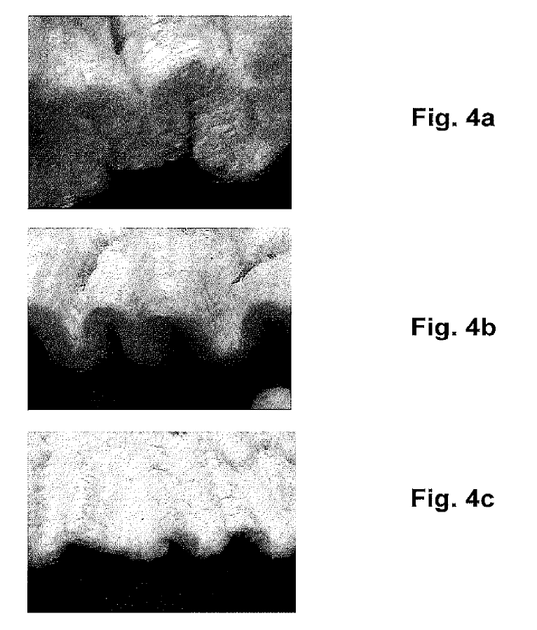

FIGS. 4a-c illustrate representations of fiber tow 18 at different stages of the process of FIG. 1. Specifically, FIG. 4a depicts an example of fiber tow 18 after exiting stuffer box 14 and before entering relaxing oven 26. As shown in FIG. 4a, at this stage, FIG. 4a is in its most compact form (i.e., has the highest bulk and CTU values). FIG. 4b depicts an example according to the present disclosure of fiber tow 18 after exiting relaxing oven 26 and after crystallization and shrinkage has set in. As shown in FIG. 4b, at this stage, there is substantially low separation between secondary crimps 22 of fiber tow 18, and thus, most of the bulk and CTU is retained in the disclosed embodiment. Contrastingly, FIG. 4c depicts an example of fiber tow 18 after exiting the relaxing oven, when using prior art systems, where the opening of the unrelaxed fiber tow has occurred through conveying and drop off of the fiber tow to oven belt.. As shown in FIG. 4c, separation between secondary crimps 22 of fiber tow 18 is substantially higher than fiber tow 18 shown in FIG. 4b.

Thus, the present disclosure provides a method of handling fiber tow 18 after exiting stuffer box 14 and prior to entering relaxing oven 26 to substantially increase bulk and CTU values. In addition, because the process involves mechanical crimping, fibers having a wide range of dpf values and cross sections may be used. As a result, the disclosed process may increase compression support and loft of products using the disclosed fiber tow, thereby reducing an amount of material used and production costs.

The fiber tow of the present disclosure can comprise fibers from fiber forming polymers known in the art. In one nonlimiting embodiment, the fibers can be made from polymers chosen from polyesters, polyamides, polyolefins and combinations thereof.

Nonlimiting examples of such fibers include fibers that may be made from polyesters, including polyethylene terephthalate, polytrimethylene terephthalate, polybutylene terephthalate, polyethylene naphthalate, polylactic acid (PLA) and blends or copolymers thereof. In one embodiment, the fibers may be made of polyethylene terephthalate. In other embodiments, the fibers may be made of polyamides, including nylon 5,6; nylon 6/6; nylon 6; nylon 7; nylon 11; nylon 12; nylon 6/10; nylon 6/12; nylon DT; nylon 6T; nylon 61; and blends or copolymers thereof. In further embodiments, the fibers may be made of polyolefins, including polyethylene or polypropylene.

The fibers in accordance with the present disclosure can have dpf values ranging from about 0.5 dpf to about 40 dpf. Non-limiting examples include dpf values ranging from about 0.5 dpf to about 30 dpf, about 0.5 dpf to about 20 dpf, about 0.5 dpf to about 10 dpf, about 0.5 dpf to about 5 dpf, about 0.5 dpf to about 3 dpf, about 0.5 dpf to about 2 dpf, about 0.5 dpf to about 1.5 dpf, about 1 dpf to about 10 dpf, about 1 dpf to about 5 dpf, about 1 dpf to about 3 dpf, about 5 dpf to about 30 dpf, about 5 dpf to about 20 dpf, about 5 dpf to about 10 dpf, about 5 dpf to about 40 dpf and about 5 dpf to about 7 dpf. In certain embodiments, system 10 may be used with fibers having dpf values of less than about 10 dpf, such as less than about 7 dpf, less than about 5 dpf, less than about 3 dpf, and less than about 1.5 dpf.

It is well known in the art that properties such as higher bulk and CTU values vary for fibers when the dpf is changed. The fiber tows of the current invention show surprising improvement in CTU for both high dpf and low dpf fibers.

In one aspect of the current invention, A fiber tow is disclosed comprising a plurality of mechanically crimped fibers with a primary crimp having a saw tooth crimp shape, wherein the average denier per filament of the fibers is greater than about 5, and wherein the plurality of mechanically crimped fibers have an average crimp take-up of greater than about 40%. In one nonlimiting embodiment, the plurality of mechanically crimped fibers have an average crimp take-up of ranging from about 40% to about 75%. In another nonlimiting embodiment, the plurality of mechanically crimped fibers have an average crimp take-up greater than about 50%. In another nonlimiting embodiment, the fibers have a dpf value ranging from about 5 dpf to about 7 dpf and an average crimp take-up of greater than 50%.

In another aspect of the current invention, A fiber tow is disclosed comprising a plurality of mechanically crimped fibers with a primary crimp having a saw tooth crimp shape, wherein the average denier per filament of the fibers is less than about 5, and wherein the plurality of mechanically crimped fibers have an average crimp take-up of greater than about 30%. In one nonlimiting embodiment, the plurality of mechanically crimped fibers have an average crimp take-up of ranging from about 30% to about 75%. In another nonlimiting embodiment, the plurality of mechanically crimped fibers have an average crimp take-up greater than about 40%. In another nonlimiting embodiment, the plurality of mechanically crimped fibers have an average crimp take-up greater than about 50%. In another nonlimiting embodiment, the fibers have a dpf value ranging from about 1 dpf to about 3 dpf and an average crimp take-up of greater than 40%.

In accordance with the present disclosure, the mechanically crimped fiber tow disclosed herein may be used in a variety of diverse products, including both woven and non-woven products. Depending on the end use, the fiber tow may be cut or used in uncut, continuous form. Non-limiting examples of the products include: finished bedding products, such as pillows, duvets, quilts, and comforters; furniture components, such as seat cushions and chair backings; stuffing for toys; sleeping bags; and apparel, such as outerwear, thermal products, and insulated clothing. In some embodiments, the insulated clothing may include shirts, pants, and any other apparel articles.

In some embodiments, the finished bedding products, such as pillows, may be comprised of a plurality of staple fiber bundles. As used herein, “staple fiber bundles” refers to segments of the fiber tow that can be cut to lengths of about 5 mm to about 200 mm. In some embodiments, the staple fiber bundles may have lengths ranging from, for example, about 10 mm to about 175 mm, about 15 mm to about 150 mm, about 20 mm to about 125 mm, about 25 mm to about 100 mm, and from of about 25 mm to about 76 mm. In one example, the staple fiber bundles have lengths of about 32 mm. In another example, the staple fiber bundles have lengths of about 64 mm. In certain embodiments, the pillows can have a length and width of about 20″×26″, and can be filled with about 10 oz to 60 oz of staple fiber bundles. For lower denier pillows (about 1-2 dpf), the plurality of staple fiber bundles in the pillow may have a weight range of about 22 oz to 45 oz. For higher denier pillows (about 6 dpf), the plurality of staple fiber bundles in the pillow may have a weight range of about 10 oz to 26 oz.

To illustrate differences between the disclosed system and the prior art systems, a number of tests were conducted. It should be noted that multiple parameters contribute to imparting of primary and secondary crimp including, among other things, a fiber orientation, a temperature of the tow going into the crimping wheel, an amount of heat while inside the stuffer box, and an amount of pressure imparted on the tow from the stuffer box flap. However, all of these parameters were fixed during the tests described below. A control test using a prior art system described in FIG. 2, and an enhanced test using the disclosed system described in FIG. 3, were run back-to-back using the same equipment. The only difference between the control and enhanced tests was how the fiber tow was handled after exiting the stuffer box.

During the tests, two different samples were used for each of the control and enhanced tests: (1) a 6 dpf sample, and (2) 1.2 dpf sample. The tests included three different measurements: (1) pillow bulk measurement, (2) total bulk range measurement (TBRM), and (3) crimp take-up (CTU). For the purposes of the present disclosure, the measurement methods for pillow bulk, TBRM bulk, and CTU are described in detail below.

The pillow bulk measurement was performed by first placing a predetermined amount of fibers (e.g., 18 oz.) into a pillow tick. Then, the formed pillow was laid on a load-sensitive table for measurement. While under zero load, a height of the pillow at its lengthwise center H_{O}(e.g., center height) was measured. Next, a load of about 10 pounds was applied to the lengthwise center of the pillow via a presser foot having a 4-inch diameter, representing an approximation of a human head resting on a pillow. The center height of the pillow after loading H_{L} was then measured. Finally, the H_{O} and H_{L} values were compared. Fibers having higher H_{L} values may have higher pillow bulk. It should be noted that this method may be considered a “constrained bulk” measurement because the fibers are constrained within a flexible structure, i.e., the pillow ticking.

For the pillow bulk tests, the 1.2 dpf and 6 dpf samples were prepared slightly different. The 1.2 dpf fiber tow had a short cut length and was blown into a 220 thread count cotton ticking measuring about 20×26 inches when flat. About 22 ounces of cut fiber tow was blown into the ticking to make the pillow. On the other hand, the 6 dpf fiber tow had long cut length and was carded and rolled to make a fiber batting. About 18 cut ounces of fiber tow was used to make the fiber batting.

The TBRM bulk measurement was performed by cutting 6 inch squares of fiber tow and stacking the squares in a cross-lapped manner until their total weight was about 20 grams. The entire area was then be compressed in an Instron under a load cell capable of about 50 pounds (22.7 kilograms). The stack height was recorded (after one conditioning cycle under a load of 2 pounds) for heights at loads of 0.001 (for BL₁) and 0.2 (for BL₂) pounds per square inch (0.00007 and 0.014 kilograms per square centimeter, respectively) gage. The load at 0.001 psi was about 0.036 lbs, and the load at 0.2 psi was about 7.2 lbs. BL₁was the initial height, or bulk, and is a measure of filling power, while BL₂ was the height under load, or residual bulk, and is a measure of support bulk. Fibers resulting in higher BL₂ values may have higher TBRM bulk. It should be noted that this method may be considered an “unconstrained bulk” measurement because the fibers are free from an exterior constraint.

The crimp take-up (CTU) measurement was performed by cutting the fiber tow into single filament fibers or small bundles of between 10 and 50 filaments, herein referred to as filament bundles. Twenty filament bundles are were then randomly selected. Each filament bundle was measured at a relaxed state (i.e., upstretched) and at a fully-stretched state (i.e., stretched to a substantially uncrimped state). In particular, each filament bundle was placed between a tweezer attached to a sliding ruler to hold a first end of the filament bundle. While the filament bundle was in the relaxed state, a relaxed length L₁ was measured. Only the weight of the filament bundle is used to determine the relaxed length L₁. Then, a second end of the filament bundle was pulled with another tweezer and stretched until all primary and secondary crimp is pulled out. While the filament bundle was in the fully-stretched state, a stretched length L₀ was measured. The CTU value for each filament bundle was calculated using both the relaxed length L₁ and the stretched length L₀ in the follow equation, Eq. 2 below. The CTU values for each of the twenty randomly selected filament bundles was calculated and then averaged to obtain an average CTU value for the filament bundles.

$$CTU = \frac{{L}_{0} - {L}_{1}}{{L}_{0}} \times 100 \% \qquad Eq . 2$$

As shown below, Tables 1 and 2 compiled data gathered from the testing. An explanation of the results follow the tables. The term “siliconized” used in Tables 1 and 2 means that the surface of the polyester fiber is coated with a silicone polymer. The silicone, also called organosiloxanes or polysiloxanes, bonds well with polyester fibers, and reduces friction to improve the durability and the hand of the article. The silicone coating adheres to the fiber and does not come off after repeated washings. It also provides durability of high loft non-woven by allowing fibers to more easily slide past each other and springing back to original position rather than nesting.

TABLE 1
Bulk Evaluation by Pillow Compression

| | | Height of | | | | |
|---|---|---|---|---|---|---|
| | | Pillow at Loading, | | Bulk Improvements | | |
| | Weight | inches | | Δ Bulk | Δ Bulk | Weight |
| Fiber Type | of Pillow oz. | 0 lbs | 10 lbs | %, 0 lb | %, 10 lb | Reduction |
| Control, 6 dpf, siliconized | 18.0 | 7.84 | 2.21 | | | |
| Enhanced, 6 dpf, | 18.0 | 8.38 | 3.18 | 7% | 44% | |
| siliconized. | | | | | | |
| Enhanced, 6 dpf, | 15.0 | 8.84 | 2.57 | 13% | 16% | 17% |
| siliconized. | | | | | | |
| Enhanced, 6 dpf, | 14.0 | 8.01 | 2.11 | −6% | 3% | 22% |
| siliconized. | | | | | | |
| Enhanced, 6 dpf, | 13.0 | 7.29 | 1.60 | −7% | −28% | |
| siliconized. | | | | | | |
| Control, 1.2 dpf, | 22.0 | 6.55 | 1.50 | | | |
| siliconized | | | | | | |
| Enhanced, 1.2 dpf, Slick | 22.0 | 8.28 | 2.66 | 26% | 77% | 0% |
| Enhanced, 1.2 dpf, Slick | 19.0 | 7.82 | 1.98 | 19% | 32% | 14% |
| Enhanced, 1.2 dpf, Slick | 18.0 | 8.05 | 1.68 | 23% | 12% | 18% |
| Enhanced, 1.2 dpf, Slick | 17.0 | 7.45 | 1.26 | 14% | −16% | 23% |

Note:
The interpolated weight between 17 and 18 oz pillow for a 0% bulk at 10 lbs is 17.6 oz with a weight reduction of 20%.

TABLE 2
Bulk Evaluation by TBRM and Crimp
Index (Crimp Take-Up, CTU)

| | | Crimp Index | | Bulk |
|---|---|---|---|---|
| | | Improvements | | Improvements |
| | | Δ CTU % | | Δ Bulk %, |
| | | relative to | | relative to |
| Fiber Type | CTU | control | BL2 | control |
| Control, 1.2 dpf, | 29% | 55% | Short Cut | |
| siliconized | | | Length | |
| Enhanced, 1.2 dpf, | 45% | | Short Cut | |
| siliconized. | | | Length | |
| Control, 6 dpf, | 37% | 42% | 0.482 | 37% |
| siliconized | | | | |
| Enhanced, 6 dpf, | 53% | | 0.661 | |
| siliconized. | | | | |

TABLE 3
Crimps per inches of samples

| | 6.0 dpf | 6.0 dpf | 1.2 dpf | 1.2 dpf |
|---|---|---|---|---|
| | control | Enhanced | control | Enhanced |
| Average | 4.6 | 4.8 | 7.9 | 7.2 |
| Lower | 3.5 | 3.5 | 5.5 | 5.5 |
| Upper | 5.5 | 5.5 | 9.5 | 9.5 |

As shown in Tables 1 and 2, for the 1.2 dpf sample, the enhanced pillow bulk values improved greater than 100% compared to pillows formed by the control. Specifically, the pillow bulk of the enhanced was 3.1 inches as compared to 1.5 inches for the control. The results of the pillow bulk test also showed an effective weight reduction of at least about 20%. The TBRM bulk data was not included in this disclosure because it was difficult to conduct the TBRM test due to the short cut length of the 1.2 dpf samples. The CTU values for the 1.2 dpf sample showed a 55% increase of the enhanced sample when compared to that of the control. In particular, a CTU values of the enhanced sample were 45% compared to a CTU value of 29% for the control.

For the 6.0 dpf sample, the enhanced pillow bulk values improved greater than 40% compared to pillows formed by the control. Specifically, the pillow bulk of the enhanced sample was 3.2 inches as compared to 2.2 inches for the control. The results of the pillow bulk test also showed an effective weight reduction of about 20%. The TBRM bulk for the enhanced sample was greater than 35% compared to the control. Specifically, the support bulk value was 0.66 inches for the enhanced sample compared to 0.48 inches for the control. The CTU values for the 6.0 dpf sample showed a 42% increase of the enhanced sample compared to that of the control. In particular, the CTU values of the enhanced were 53% compared to 37% for the control.

Several advantages over the prior art may be associated with the disclosed fiber tow and the process in mechanically crimping the fiber tow. The disclosed fiber tow may have increased bulk and CTU values in all denier ranges. Specifically, the disclosed fiber tow may have increased bulk and CTU values in denier ranges below about 5 dpf. In addition, the disclosed system may allow less material to be used in non-woven products, thereby reducing costs of production and environmental footprint.

It will be apparent to those skilled in the art that various modifications and variations may be made to the disclosed fiber tow. Other embodiments will be apparent to those skilled in the art from consideration of the specification and practice of the disclosed fiber tow. It is intended that the specification and examples be considered as exemplary only, with a true scope being indicated by the following claims and their equivalents.

What is claimed is:

1. A fiber tow, comprising a plurality of mechanically crimped fibers with a primary crimp having a saw tooth crimp shape, wherein the average denier per filament of the fibers is greater than about 5, and wherein the plurality of mechanically crimped fibers have an average crimp take-up of greater than about 40%.

2. The fiber tow according to claim 1, wherein the plurality of mechanically crimped fibers have an average crimp take-up of ranging from about 40% to about 75%.

3. The fiber tow according to claim 1, wherein the plurality of mechanically crimped fibers have an average crimp take-up greater than about 50%.

4. The fiber tow according to claim 1, further comprising a secondary crimp having from about 2 crimps to about 20 crimps per inch.

5. The fiber tow according to claim 4, wherein the secondary crimp value ranges from about 4 crimps per inch to about 8 crimps per inch.

6. The fiber tow according to claim 4, wherein the ratio of the primary crimp to the secondary crimp ranges from about 20:1 to about 2:7.

7. The fiber tow according to claim 4, wherein the ratio of the primary crimp to the secondary crimp ranges from about 5:1 to 5:7.

8. The fiber tow according to claim 1, wherein the fibers are made from polymers chosen from polyesters, polyamides, polyolefins and combinations thereof.

9. The fiber tow according to claim 1, wherein the fibers are made from polyethylene terephthalate.

10. The fiber tow according to claim 1, wherein the fibers have a dpf value ranging from about 5 dpf to about 40 dpf.

11. The fiber tow according to claim 1, wherein the fibers have a dpf value ranging from about 5 dpf to about 7 dpf and an average crimp take-up of greater than 50%.

12. A fiber tow, comprising a plurality of mechanically crimped fibers with a primary crimp having a saw tooth crimp shape, wherein the average denier per filament of the fibers is less than about 5, and wherein the plurality of mechanically crimped fibers have an average crimp take-up of greater than about 30%.

13. The fiber tow according to claim 12, wherein the plurality of mechanically crimped fibers have an average crimp take-up of ranging from about 30% to about 75%.

14. The fiber tow according to claim 12, wherein the plurality of mechanically crimped fibers have an average crimp take-up greater than about 40%.

15. The fiber tow according to claim 12, wherein the plurality of mechanically crimped fibers have an average crimp take-up greater than about 50%.

16. The fiber tow according to claim 12, further comprising a secondary crimp having from about 2 crimps to about 20 crimps per inch.

17. The fiber tow according to claim 16, wherein the secondary crimp value ranges from about 4 crimps per inch to about 8 crimps per inch.

18. The fiber tow according to claim 16, wherein the ratio of the primary crimp to the secondary crimp ranges from about 20:1 to about 2:7.

19. The fiber tow according to claim 16, wherein the ratio of the primary crimp to the secondary crimp ranges from about 5:1 to 5:7.

20. The fiber tow according to claim 12, wherein the fibers are made from polymers chosen from polyesters, polyamides, polyolefins and combinations thereof.

21. The fiber tow according to claim 12, wherein the fibers are made from polyethylene terephthalate.

22. The fiber tow according to claim 12, wherein the fibers have a dpf value ranging from about 0.5 dpf to about 5 dpf.

23. The fiber tow according to claim 12, wherein the fibers have a dpf value ranging from about 1 dpf to about 3 dpf and an average crimp take-up of greater than 40%.

24. An article of manufacture comprising a plurality of fiber tows from any of claims 1-24.

25. A pillow comprising a plurality of fiber tows from any of claims 1-24.

26. A batting comprising a plurality of fiber tows from any of claims 1-24.

27. A process for forming a fiber tow including a plurality of mechanically crimped fibers, the process comprising:
a) conveying a fiber tow including a plurality of substantially uncrimped fibers towards a stuffer box;
b) imparting a primary mechanical crimp in a saw tooth crimp shape on the fiber tow;
c) conveying the fiber tow including a plurality of substantially crimped fibers in a substantially compacted form immediately into a relaxing oven; and
d) heating the fiber tow via the relaxing oven to crystalize and shrink the fiber tow.

28. The process of claim 27, further including cooling the fiber tow exiting the relaxing oven to a temperature below a glass transition temperature of the fiber tow.

29. The process of claim 27, wherein the average crimp take-up the fiber tow formed is at least 40% greater than the average crimp take-up a fiber tow not subject to step (c).
